(19) United States
(12) Patent Application Publication
(10) Pub. No.: US 2020/0100619 A1
(43) Pub. Date: Apr. 2, 2020

(54) BREWING DEVICE FOR PREPARING A HOT BEVERAGE AND ASSOCIATED METHOD

(71) Applicant: JURA Elektroapparate AG, Niederbuchsiten (CH)

(72) Inventors: Shahryar REYHANLOO, Immensee (CH); Philipp BUETTIKER, Oberbuchsiten (CH)

(73) Assignee: JURA Elektroapparate AG, Niederbuchsiten (CH)

(21) Appl. No.: 16/469,205

(22) PCT Filed: May 17, 2018
(86) PCT No.: PCT/CH2018/000024

§ 371 Date: Jun. 13, 2019

(30) Foreign Application Priority Data
May 18, 2017 (EP) 17171732.5

(51) Int. Cl. A47J 31/46; A47J 31/00; A47J 31/36; A47J 31/44; A47J 31/52

(52) U.S. Cl. CPC A47J 31/469; A47J 31/461; A47J 31/468; A47J 31/525; A47J 31/36; A47J 31/4489; A47J 31/002

(57) ABSTRACT

A brewing device for preparing a hot beverage includes: a hot water supply device with a hot water outlet; a brewing unit that receives hot water from the supply device and dispenses brewed hot beverage through a fluid outlet line into a hot beverage outlet; a hot water bypass line; a controllable hot water switching device temporarily connecting the bypass line to the hot water outlet, the hot water supplied into the bypass line being dispensable into the hot beverage outlet; and a control unit controlling the hot water switching device. The hot beverage outlet includes a hot beverage dispensing line, the fluid outlet line and the bypass line opening into the hot beverage dispensing line downstream of the brewing unit and the hot water switching device, respectively, to dispense by the hot beverage dispensing line the brewed hot beverage and the hot water supplied into the bypass line.

### FIELD OF THE INVENTION

The present invention relates to a brewing device for preparing a hot beverage, in particular an automatic coffee machine for preparing a coffee beverage.

### PRIOR ART

In brewing devices for preparing a hot beverage, hot water is supplied to a brewing unit in which the hot water passes through a flavoring agent (for example, coffee powder) and is dispensed at a hot beverage dispenser as a prepared or brewed hot beverage.

In particular for coffee, there are regional and cultural differences in the types of preparation. Thus, the personal preferences differ, in particular with respect to the amount of the coffee powder used or with respect to the portion size of the hot beverage. If the coffee is prepared in a larger portion, the filling amount of ground coffee powder may be varied in the brewing unit. With respect to a very large coffee, this amount is generally increased up to a maximum volumetric capacity of the respective part of the brewing chamber.

During coffee dispensing, primarily desired flavorings and aromas are dispensed at the beginning. At increasing dispensing period, the coffee becomes more watery, and undesired bitter substances may be released.

Brewing devices are known from the prior art in which two heating systems are present, i.e., continuous-flow heaters, and a dedicated supply pump and a fluid line upstream thereof are assigned to each respective heater. For example, WO 2011/151703 A2 discloses such a conventional brewing device. The two heating systems are operated in parallel during coffee dispensing. Hot water is supplied to the brewing unit using one fluid line in order to enable the brewing unit to brew a coffee beverage and to guide the brewed coffee beverage into a coffee dispenser, hot water is simultaneously generated within another fluid line, which is mixed in the coffee dispenser downstream of the brewing unit.

Due to the two heating systems, the conventional brewing device becomes more expensive and there are increased spatial requirements.

DE 10 2014 108 415 B3 discloses a beverage preparation device, in particular a coffee machine, which has a water pump for supplying water to a first continuous-flow heater and to a second continuous-flow heater. The first continuous-flow heater is designed for generating hot water, while the second continuous-flow heater is designed for generating hot water and/or for generating steam. The first continuous-flow heater is connected to a first input of a multi-way valve via a first connection line, while the second continuous-flow heater is connected to a second input of the multi-way valve via a second connection line. The beverage preparation machine further comprises a brewing unit for producing a beverage (e.g. coffee) with a brewing chamber which is connected to the first connection line via an overpressure valve and a line, and thus is likewise connected to the first continuous-flow heater. The brewing unit is thus suited for receiving hot water provided by the first continuous-flow heater if the first input of the multi-way valve is closed. The multi-way valve has a total of five different inputs—aside from the two inputs connected to the two continuous-flow heaters, three additional inputs which may function for aeration or venting—and additionally four outputs, which are connected to four different lines: to a steam line for supplying a milk frothing device with steam; an air and cleaning line for supplying an air supply of the milk frothing device; a hot water line for supplying a hot water dispensing tap with hot water, an additional line for connecting the multi-way valve to an expansion housing for discharging residual fluids from the multi-way valve into a drip tray arranged downstream of the expansion housing. The multi-way valve may be brought into different switching states in order to achieve selectively that: hot water is supplied to the hot water dispensing tap from the two continuous-flow heaters; the milk frothing device is supplied with steam and air to generate frothed milk or is supplied with water and/or steam for cleaning purposes; residual fluid is guided from the outlet of the multi-way valve into the drip tray. An outlet line, via which a beverage (i.e. coffee) prepared in the brewing unit may be dispensed into a beverage container, is connected to the brewing unit. All lines, which are connected to an output of the multi-way valve, run separately from the outlet line to dispense a beverage and in particular do not open into this outlet line. It is therefore not provided to dilute a beverage prepared in the brewing unit by mixing with a portion of hot water that has not flowed through the brewing unit.

### BRIEF SUMMARY OF THE INVENTION

It is the object of the present invention to refine a brewing device or a method which uses a brewing device in such a way that the brewing device is less expensive or that the spatial requirements are reduced.

The problem is solved by a brewing device according to claim 1 or a method according to claim 14.

According to one aspect, a brewing device for preparing a hot beverage has: a hot water supply device with an outlet for hot water; a brewing unit for carrying out a brewing process for preparing a brewed hot beverage, which has a fluid outlet line and is configured for receiving hot water from the hot water supply device during the brewing process and for dispensing the brewed hot beverage through the fluid outlet line into a hot beverage outlet; a hot water bypass line; a controllable hot water switching device which is configured for temporarily connecting the hot water bypass line to the outlet of the hot water supply device so that hot water from the hot water supply device is enabled to be supplied into the hot water bypass line, wherein the hot water bypass line extends in such a way that hot water supplied into the hot water bypass is enabled to be dispensed into the hot beverage outlet; a control unit for controlling the hot water switching device.

According to the invention, the hot beverage outlet comprises at least one hot beverage dispensing line, wherein the fluid outlet line opens into the at least one hot beverage dispensing line downstream of the brewing unit, such that the brewed hot beverage is enabled to be dispensed through the at least one hot beverage dispensing line of the hot beverage outlet, and wherein the hot water bypass line opens into the at least one hot beverage dispensing line downstream of the hot water switching device so that hot water is enabled to be dispensed through the at least one hot beverage dispensing line of the hot beverage outlet.

This brewing device is designed in particular as an automated coffee machine.

The hot water bypass line thus guides hot water in a controllable or switchable way from the same hot water supply device, which also supplies the brewing unit, to the at least one hot beverage dispensing line of the hot beverage outlet. It is thus possible, in contrast to a conventional brewing device according to WO 2011/151703 A2, to lower the costs of the brewing device or to reduce the spatial requirements. At the same time, it may be ensured that, in particular in the case of a large portion size of the hot beverage to be prepared, not too much hot water is guided through the brewing unit in a controllable way. By this means, the quality of the hot beverage to be prepared may be maintained or improved; in particular, during the preparation of a coffee beverage, it may be ensured that only a little or no bitter substances are released from the coffee powder.

In other words: it may be ensured for a large hot beverage portion to be prepared, that a smaller amount of hot water than the total portion size is guided through the brewing unit, without providing additional parts, like a second heating system. Thus, in the case of a coffee preparation, less heated water flows through the ground coffee powder (located in the brewing unit), by which means an over-extraction of flavoring substances may be prevented and the release of bitter components into the prepared coffee is reduced. By this means, desired flavorings and aromas may be discharged during the brewing process and no or only small amounts of undesired bitter substances are released. At the same time, it is possible to obtain a sufficiently large portion at the hot beverage outlet via a single hot beverage dispensing line.

The hot water supply device is, for example, designed as a combination of a cold water reservoir, a supply pump, and a continuous-flow heater, however, not limited to the same. Alternatively, it is also possible to store hot water in a hot water tank or boiler, and to supply the heated water using the supply pump. In each case, the heated water is available at an outlet of the hot water supply device, and may be supplied directly or indirectly into the brewing unit, and may be supply directly or indirectly into the hot water bypass line, namely depending on a switching state of the hot water switching device.

Hot water, as used hereby, relates to water with a suitable temperature for preparing the desired hot beverage, for example, coffee brewing temperature. Typical brewing temperatures are more than 90° C., in particular more than 95° C.

According to another aspect, the hot water supply device is configured to supply hot water from a single hot water source. The hot water source is, for example, the hot water tank or boiler mentioned above, or the hot water source is the outlet of the continuous-flow heater described above. In the case of a hot water tank or boiler, the hot water is used according to the aspect from one and the same hot water tank or boiler both for supplying the brewing unit and also for supplying the hot water bypass line, depending on the switching state of the hot water switching device. Correspondingly, in the case of a continuous-flow heater, the hot water is used according to the aspect from one and the same continuous-flow heater both for supplying the brewing unit and also for supplying the hot water bypass line, depending on the switching state of the hot water switching device.

One embodiment of the brewing device is designed in such a way that the hot water switching device is controllable by means of the control unit in such a way that the hot water bypass line is connected at least temporarily to the hot water supply device during the brewing process. By this means, it is guaranteed that, during the brewing process, both hot water dispensed from the hot water supply device may be supplied to the brewing unit, in order to enable the preparation of a brewed hot beverage in the brewing unit and a dispensing of the brewed hot beverage through the at least one hot beverage dispensing line of the hot beverage outlet, and also hot water dispensed from the hot water supply device may be dispensed through the hot water bypass line through the same hot beverage dispensing line of the hot beverage outlet, through which the hot beverage brewed in the brewing unit is dispensed from the hot beverage outlet.

In embodiments of the brewing device, the hot water supply device is designed to dispense a predefined amount of hot water during the brewing process via the outlet of the hot water supply device, wherein the hot water switching device is controllable by the control unit in such a way that the hot water bypass line is connected temporarily during the brewing process to the hot water supply device, and a part of the predefined amount of hot water dispensed via the outlet of the hot water supply device is enabled to be dispensed through the at least one hot beverage dispensing line of the hot beverage outlet. Furthermore, the brewing unit has an inlet for receiving hot water, said inlet being connected to the outlet of the hot water supply device via a fluid line, so that the other part of the predefined amount of hot water dispensed via the outlet of the hot water supply device is enabled to be supplied to the inlet of the brewing unit during the brewing process.

In embodiments of the brewing device, the hot water switching device is a valve, in particular a 2/2-way solenoid valve, which has an inlet and an outlet. In a throughput position of the valve, the inlet is connected to the outlet. In an interrupted position of the valve, the inlet is not connected to the outlet. The inlet of the valve is connected to the outlet of the hot water supply device. In the interrupted position, however, no hot water being present at the inlet of the valve arrives at the outlet of the valve. The outlet of the valve is connected to the hot water bypass line. A fluid line upstream of the inlet of the valve establishes a connection between the outlet of the hot water supply device and an inlet of the brewing unit. The connection between the outlet of the hot water supply device and the inlet of the brewing unit is, in particular, continuously present or is not controllably interruptible.

In the interrupted position of the valve, the hot water is supplied to the brewing unit. The brewing chamber of the brewing unit, filled during the brewing process with, for example, coffee powder, has a comparatively high flow resistance, while the hot water bypass line has a comparatively low flow resistance. Therefore, in the throughput position, a large portion of the hot water, which is present at the inlet of the valve, flows into the hot water bypass line.

Alternatively, in embodiments of the brewing device, the hot water switching device is a valve, in particular a 3/2-way solenoid valve, which has one inlet, one first outlet and one second outlet. In a first position, the inlet is connected to the first outlet. In a second position, the inlet is connected to the second outlet. The inlet of the valve is connected to the outlet of the hot water supply device. The first outlet of the valve is connected to the hot water bypass line. The second outlet of the valve is connected to an inlet of the brewing unit.

In the first position of the valve, the hot water, which is present at the inlet of the valve, flows into the hot water bypass line. In the second position of the valve, the hot water, which is present at the inlet of the valve, flows into the inlet of the brewing unit.

In embodiments of the brewing device, the control unit is configured in order to control the hot water switching device during the brewing process in at least one time interval or in a plurality of time intervals in such a way that each time interval comprises a first time period in which the hot water bypass line is connected to the hot water supply device, and a second time period in which the hot water bypass line is not connected to the hot water supply device.

The switching in at least one interval leads to the fact that the water remains in the brewing unit during the first time period. In the case of a coffee preparation, the brewing water thus has an extended contact period with the coffee powder in the brewing chamber of the brewing unit, which may thus contribute to improving the solubility of the flavorings and aromas.

In the case of a plurality of intervals, a plurality of pressure pulses is created in the brewing unit. This may additionally promote aroma extraction or a squeezing out of the powder body of the coffee powder and additionally improve the quality of the hot beverage dispensed. The pressure difference within one pressure pulsation is briefly, for example, up to 15 bar.

In embodiments of the brewing device, the ratio of the first time period to the second time period of the interval or of the intervals is predefined or predefinable, namely as a function of the type of hot beverage to be prepared. For example, it may be provided that for certain types of hot beverages, e.g. espresso or ristretto, a ratio of zero may be predefined, i.e., that for these types, the hot water is guided exclusively through the brewing unit during the entire preparation process and not guided through the hot water bypass line. Correspondingly, it may be provided that, for other types of hot beverages, e.g. coffee Americano, a ratio may be predefined which differs from zero, so that a certain proportion of hot water is guided past the brewing unit during the preparation process and through the hot water bypass line.

As non-limiting example, the first time period is 0.5 seconds and the second time period is 0.5 seconds; or the first time period is 0.3 seconds and the second time period is 0.6 seconds; or the first time period is 1.0 seconds and the second time period is 0.4 seconds. During a sequence of a plurality of intervals, the first time period of a subsequent interval typically directly follows the second time period of the respective previous interval.

In embodiments of the brewing device, the first time period of at least one of the intervals, typically the first time period of each interval, is shorter than the associated second time period of the respective interval.

Embodiments of the brewing device additionally have a volume measuring device. The volume measuring device is configured to measure a volume of the fluid dispensed into the hot beverage outlet as a function of time and to output the associated measured values to the control unit. Furthermore, the control unit is configured to control the hot water switching device depending on the measured values from the volume measuring device. Typically, the volume per preparation process of a hot beverage is measured, i.e. the initial volume at the beginning of a preparation process is assumed to be 0. The volume measuring device may output the volume dispensed directly or indirectly into the hot beverage outlet continuously or at predefined measurement value intervals to the control unit.

Furthermore, in embodiments, the control unit is configured to control the hot water switching device, in particular switching in a plurality of intervals, if it is determined according to the measured values from the volume measuring device that a first volume has been reached.

For example, the hot water switching device may be controlled during the brewing process by the control unit in such a way that the hot water switching device is switched alternatingly between a first position, in which the hot water bypass line is not connected to the hot water supply device, and a second position, in which the hot water bypass line is connected to the hot water supply device if a measured value, determined by the volume measuring device, for the volume of the liquid dispensed into the hot beverage outlet is greater than or equal to a first predefined volume. It may also be provided that the control unit switches the hot water switching device upon reaching a certain volume, the first volume. For example, the control unit switches the hot water switching device upon reaching the specified volume from the position, in which the hot water bypass line is not connected to the hot water supply device, into the position, in which the hot water bypass line is connected to the hot water supply device. For example, the control unit switches the hot water switching device after the expiration of a specified time back into the position, in which the hot water bypass line is not connected to the hot water supply device.

It may also be provided that the control unit switches the hot water switching device upon reaching the first volume in intervals, typically in a plurality of intervals, as described herein.

In addition, it may be provided that the control unit is further configured to end the control of the hot water switching device if a measured value, determined by the volume measuring device, for the volume of the liquid dispensed into the hot beverage outlet is greater than or equal to a second predefined volume, wherein the second, predefined volume is greater than or equal to the first, predefined volume. The control unit thus controls the hot water switching device in the time period from reaching the first volume up to reaching the second volume.

This control may in turn provide that, at the beginning of this volume-related time period, the control unit switches the hot water switching device, upon reaching the specified volume, from the position, in which the hot water bypass line is not connected to the hot water supply device, into the position, in which the hot water bypass line is connected to the hot water supply device, and after the expiration of this volume-related time duration, switches the hot water switching device back into the position, in which the hot water bypass line is not connected to the hot water supply device.

However, this control may also provide that, at the beginning of this volume-related time period, the control unit, upon reaching the specified volume, switches the hot water switching device in intervals, as described herein, and after the expiration of this volume-related time period, ends the intermittent switching.

Embodiments of the brewing device are further configured to supply steam to the hot water bypass line. The steam may be dispensed, in particular, in the form of a steam surge. Thus, the line system downstream the brewing unit may be emptied in the direction of the hot beverage outlet; at the same time, the line system downstream of the brewing unit and the hot beverage outlet may be hygienically cleaned by the steam. For example, bacteria are killed by the steam.

According to one aspect, a method for preparing a hot beverage in a brewing device described herein has a determination of a type of the hot beverage to be prepared, a specification, depending on the type of hot beverage to be prepared, of at least one parameter for controlling the hot water switching device, and a control, by means of the control unit, of the hot water switching device according to the at least one parameter during the preparation of the hot beverage.

It is, for example, possible that the parameter for a type of hot beverage to be provided, indicates that no switching is to be carried out during the preparation in such a way that the hot water bypass line is connected to the hot water supply device. This may, for example, be a given for an espresso or ristretto beverage. The parameter may also indicate for a type of hot beverage to be provided, that a specified number of switching processes, for example, a single switching process or a plurality of switching intervals, is to be carried out, i.e., a switching in such a way that the hot water bypass line is connected to the hot water supply device or that the hot water bypass line is connected to the hot water supply device in certain time periods and is not connected in other time periods.

In embodiments of the method, the parameter comprises a volume of the liquid dispensed into the hot beverage outlet. For example, the parameter comprises a first volume, upon reaching or exceeding the same, a single or multiple intermittent switching is carried out. In addition, the parameter comprises, for example, a second volume, upon reaching or exceeding the same, a multiple intermittent switching is ended.

In embodiments of the method, the parameter alternatively or additionally comprises a first time period of an interval, in which the hot water bypass line is connected to the hot water supply device. Alternatively or additionally, the parameter comprises a second time period of an interval, in which the hot water bypass line is not connected to the hot water supply device. Alternatively or additionally, the parameter comprises a ratio of the first time period to the second time period. Alternatively or additionally, the parameter comprises a change of the ratio of the first time period to the second time period over time.

In embodiments, the method further provides that, following completion of the preparation of the hot beverage, steam, in particular in the form of a steam surge, is supplied into the hot water bypass line. The line system downstream of the brewing unit may thus be emptied in the direction of the hot beverage outlet; at the same time, the line system downstream of the brewing unit and the hot beverage outlet is hygienically cleaned by the steam. For example, bacteria are killed by the steam.

### BRIEF DESCRIPTION OF THE DRAWINGS

Exemplary embodiments of the brewing device and the associated method will be subsequently explained in greater detail on the basis of the drawings. As shown in the figures:

FIG. 1 a schematic view of a brewing device according to one embodiment;

FIG. 2 a schematic view of a brewing device according to another embodiment;

FIG. 3 brewing parameters over time of a brewing process using a brewing device according to one embodiment; and

FIG. 4 schematic pressure conditions in a brewing chamber of a brewing unit of a brewing device according to one embodiment.

### DETAILED DESCRIPTION OF EMBODIMENTS

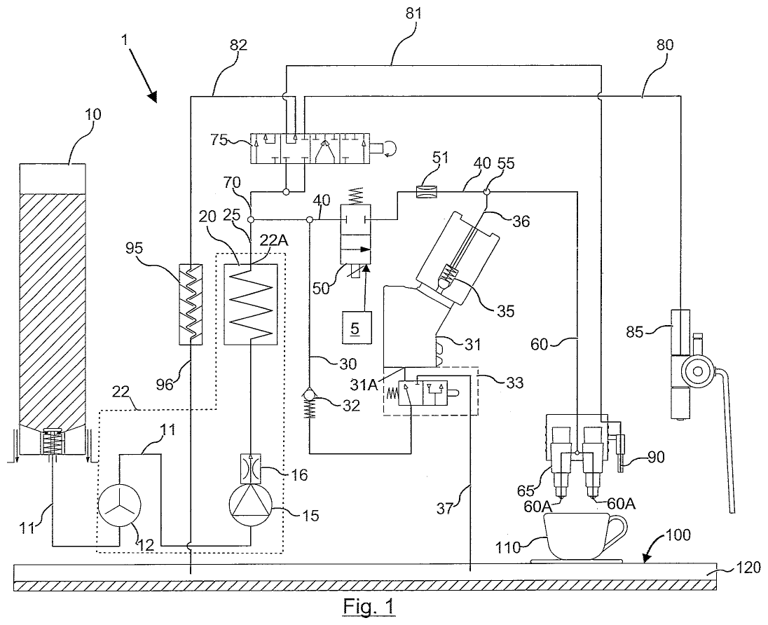

FIG. 1 shows a brewing device 1 according to one embodiment in a schematic view. Brewing device 1 has a cold water tank 10. Departing from cold water tank 10, a first fluid line 11, into which a flowmeter 12 is inserted, supplies the cold water to an arrangement of a pump 15 and a choke valve 16, from where the cold water flows through a continuous-flow heater 20 into a second fluid line 25. The arrangement of pump 15, choke valve 16 and continuous-flow heater 20 forms a hot water supply device 22 according to the embodiment depicted, wherein hot water is available at its outlet 22A, which corresponds to the outlet of continuous-flow heater 20. Hot water supply device 22 therefore supplies hot water from a single hot water source.

The supplied water flows via a third fluid line 30 via a check valve 32 to inlet 31A of a brewing unit 31. A switch valve 33 is provided upstream of inlet 31A of brewing unit 31 and may selectively supply water to the inlet of brewing unit 31 or may discharge a residual fluid, which is created, for example, after the completion of a brewing process in a brewing chamber of brewing unit 31, out of the brewing chamber of brewing unit 31 into a residual fluid container 120 via a drainage line 37.

A switching valve 75 may be switched in such a way that a fluid (hot water or steam) may be selectively delivered from a fifth fluid line 70 connected to second fluid line 25 to a hot water outlet 90 (via a fluid line 81 connected to switching valve 75), to a milk frothing device 85 (via a fluid line 80 connected to switching valve 75), or to a condensation device 95 (via a fluid line 82 connected to switching valve 75). Condensed water may drain off from condensation device 95 through another fluid line 96.

A crema valve 35 is provided at an outlet of the brewing chamber of brewing unit 31 in order to control the dispensing of fluid from the brewing chamber into a fluid outlet line 36. The fluid from the brewing chamber, thus typically the prepared hot beverage, like a coffee beverage, flows through fluid outlet line 36 and a mixing device 55, to be described later, into a hot beverage dispensing line (e.g., a coffee dispensing line) 60, and from there to a coffee outlet 65, which forms a hot beverage outlet.

A beverage container 110 is placeable on a beverage container tray 11 underneath coffee outlet 65 in order to receive the prepared hot beverage.

A fourth fluid line 40, which forms a hot water bypass line, is provided downstream of second fluid line 25, thus of the outlet of the hot water supply device and downstream of a branch point, from which the third fluid line branches off to supply hot water to brewing unit 31. A controllable hot water switching device is inserted into fourth fluid line 40 and is a 2/2-way solenoid valve 50 in the embodiment according to FIG. 1. Thus, in the embodiment according to FIG. 1, the third fluid line is permanently connected to second fluid line 25.

Valve 50 is switchable between a throughput position and an interrupted position. The switching is carried out selectively during a brewing process by means of a suitable control unit 5. During the brewing process, the flow resistance at the inlet of brewing unit 31 is comparatively high. In the interrupted position of valve 50, which is shown in FIG. 1, the valve is not permeable. Thus, the hot water flows exclusively to inlet 31A of brewing unit 31. In contrast, in the throughput position and due to the large flow resistance, a large part of the hot water flows through valve 50 and farther via a choke valve 51 to mixing device 55.

Mixing device 55 comprises a mixing chamber (not shown in the figures), which is connected both to fluid outlet line 36 and also to fourth fluid line 40 in such a way that a fluid, which flows from brewing unit 31 via fluid outlet line 36 to mixing device 55, may be mixed in the mixing chamber of mixing device 55 with a fluid, which flows from valve 50 via fourth fluid line 40 to mixing device 55. An outlet of the mixing chamber of mixing device 55 opens into hot beverage dispensing line (coffee dispensing line) 60, so that a fluid arrives into the coffee outlet 65 from the mixing chamber of mixing device 55 via hot beverage dispensing line (coffee dispensing line) 60, wherein hot beverage dispensing line 60 in the present example is branched in coffee outlet 65 into two line sections and each of these two line sections has at its end an outlet opening 60A for dispensing a hot beverage (e.g., coffee).

By this means—depending on the position of valve 50—a part of the hot water may be guided past brewing unit 31, and a good quality of the dispensed hot beverage may be guaranteed even at large volumes.

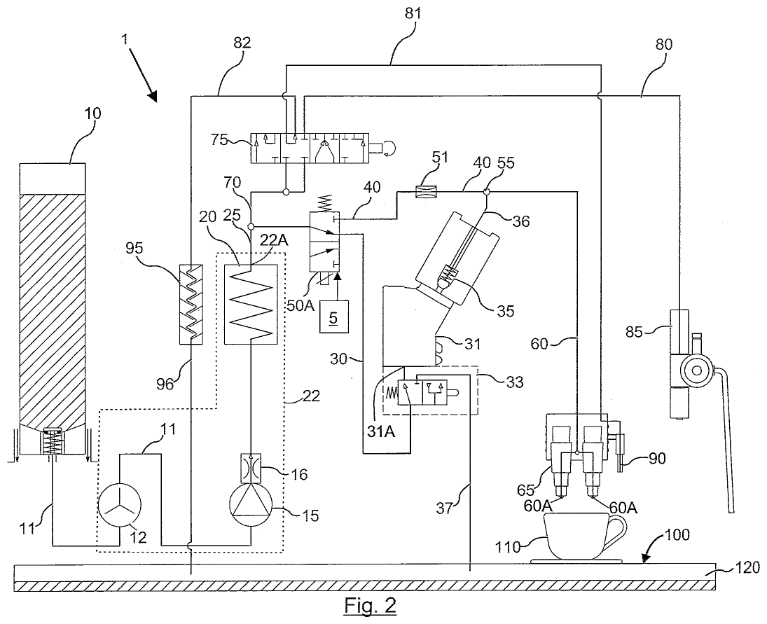

FIG. 2 shows an alternative embodiment, wherein identical reference numerals indicate identical or similar parts as in FIG. 1, and the description thereof is omitted here.

In the embodiment according to FIG. 2, a valve 50A is provided instead of valve 50, and is designed as a 3/2-way solenoid valve and has one inlet and two outlets. The inlet of valve 50A is connected to second fluid line 25 and thus to outlet 22A of hot water supply device 22. The first outlet of valve 50A is connected downstream to fourth fluid line 40, which forms a hot water bypass line. The second outlet of valve 50A is connected to inlet 31A of brewing unit 31 via third fluid line 30. In the first position of valve 50A, the inlet of valve 50A is connected to the first outlet of valve 50A; correspondingly, in the second position of valve 50A, the inlet of valve 50A is connected to the second outlet of valve 50A. Valve 50A may thus switch a dispensing of the hot water to fourth fluid line 50 and to the inlet of brewing unit 31.

Thus, in the embodiment according to FIG. 2, in one of the two positions of valve 50A, third fluid line 30 for supplying hot water into brewing unit 31 is connected to second fluid line 25, thus to outlet 22A of hot water supply device 22, and fourth fluid line 40 is blocked downstream of valve 50A. In the second of the two positions of valve 50A, fourth fluid line 40 is connected to second fluid line 25, thus to outlet 22A of hot water supply device 22, and third fluid line 30 for supplying hot water into brewing unit 31 is blocked.

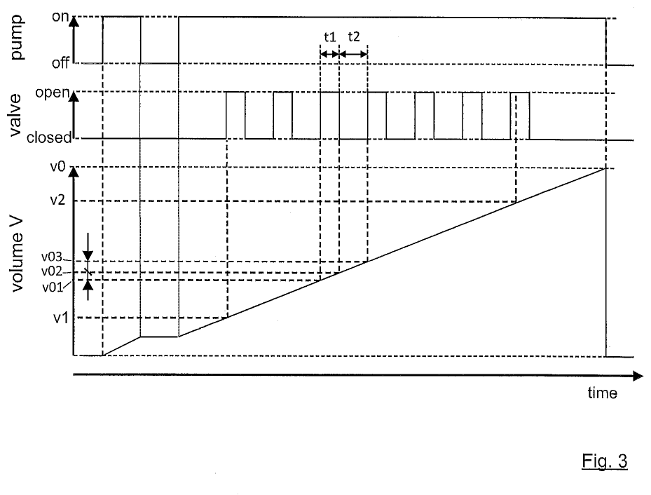

FIG. 3 shows different parameters of brewing device 1 over time during a brewing process.

In the upper part of FIG. 3, the operation of pump 15 is depicted with two states (switched on or switched off).

In the middle part of FIG. 3, the position of valve 50 is depicted from the embodiment according to FIG. 1; the valve position “open” thereby corresponds to a position in which hot water bypass line 40 is connected to hot water supply device 22, and the valve position “closed” corresponds to a position in which hot water bypass line 40 is not connected to hot water supply device 22.

In the bottom part of FIG. 3, the progression of the fluid volume V dispensed to the hot beverage outlet is depicted.

Initially, valve 50 is closed. Pump 15 is switched on and operates at a constant output, is switched off again after a specific time period, subsequently switched on again. In this pre-brewing process, the volume of the supplied brewing water increases linearly during the time that pump is switched on, i.e., brewing water is supplied to brewing unit 31 at a constant volume flow in order to wet the coffee powder in the brewing chamber of brewing unit 31. During the switched off time, the water supplied into brewing unit 31 may distributed in the coffee powder, and crema valve 35 of brewing unit 31 is closed, so that a coffee beverage is not yet dispensed during this time period.

Subsequently, pump 15 is operated again at a constant output in the switched on state up to the end of the brewing process. Volume V of the supplied brewing water again increases linearly until a volume v0 is reached and the brewing process ends.

Valve 50 is controlled depending on volume V. The valve is controlled in the embodiment by way of example in such a way that valve 50 is closed if the volume is less than a first threshold value v1. As soon as first threshold value v1 is reached, valve 50 is opened and hot water flows through fourth fluid line 40, past brewing unit 31, directly into coffee outlet 65.

Valve 50 is controlled in the example shown in intervals with one first time period t1 (valve opened) and one second time period t2 (valve closed) respectively, i.e. in a pulsed manner. The total number of time periods, in which valve 50 is open during first time period t1, may, for example, be determined at predefined parameters t1 and t2 depending on the volume of the supplied brewing water. Alternatively, valve 50 may be controlled as a function of volume V in such a way that it is opened or closed when volume V reaches certain predefined threshold values. In the example according to FIG. 3, valve 50 is opened, by way of example, when volume V reaches value v01, and subsequently closed again when volume V reaches value v02, and afterwards opened again when volume V reaches value v03. In the present example, it is assumed that the pump output of pump 15, and thus the volume flow of the water supplied by pump 15, is constant when pump 15 is switched on. In this case, the duration of time period t1 is proportional to the volume difference v02−v01, and the duration of time period t2 is proportional to the volume difference v03−v02.

In the present example, the time point, beginning at which valve 50 is held constantly closed up to the end of the brewing process, is determined as follows. A second threshold value v2 is predefined for volume V. As soon as volume V reaches threshold value v2, then it is checked whether valve 50 is already open. If valve 50 is already open (not shown in FIG. 3), then valve 50 remains open up to the end of the most recently carried out pulsed control of the duration of first time period t1; subsequently, valve 50 is closed and remains closed up to the end of the brewing process.

When volume V reaches value v0, the end of the brewing process is reached, and pump 15 is switched off.

In the example according to FIG. 3, valve 50 is repeatedly controlled through multiple pulses of period t1 and correspondingly periodically recurringly opened and closed. Alternatively, it is also conceivable that valve 50 is only to be opened during one single time interval, with a time period t1, which corresponds to a fraction of the duration of a coffee draw-off, during the course of a brewing process, and is otherwise kept closed. This single opening of valve 50 may be carried out at any time point during the brewing process, e.g., at the beginning of the respective brewing process or at the end of the respective brewing process or at another time point between the beginning and the end of the respective brewing process.

In the case of the embodiment according to FIG. 2, the control of pump 15 and valve 50A is carried out analogously to the depiction according to FIG. 3. Valve 50A according to FIG. 2 may be controlled in a pulsing way with the same pulse sequence as valve 50 in FIG. 3. If valve 50A is controlled in a pulsing way with pulses of period t1 and intervals of period t2 between two consecutive pulses, then valve 50A is brought to periodic alternation in two different states, in which third fluid line 30 for supplying hot water into brewing unit 31 is alternatingly connected to second fluid line 25 and fourth fluid line 40 is blocked downstream of valve 50A, or fourth fluid line 40 is connected to second fluid line 25 and third fluid line 30 for supplying hot water into brewing unit 31 is blocked.

Correspondingly, the hot water supplied through second fluid line 25 during the pulsed control of valve 50A flows alternatingly through third fluid line 30 or through fourth fluid line 40.

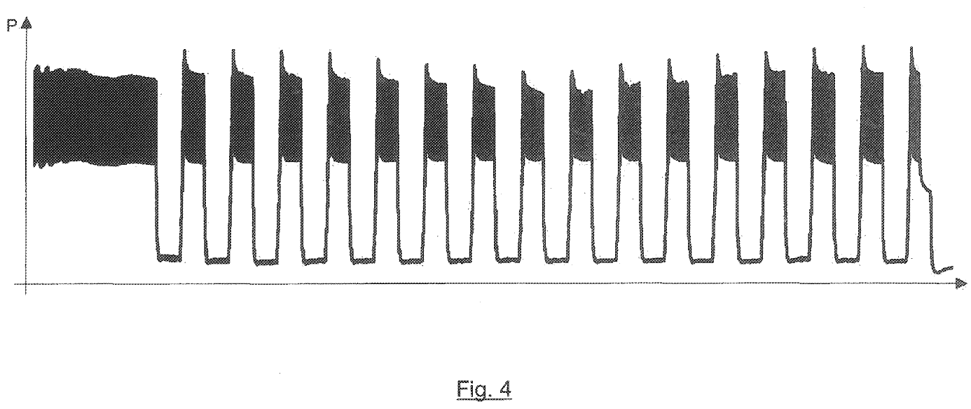

FIG. 4 shows the pressure of the brewing water in the brewing chamber of brewing unit 31 as a function of time t during a coffee draw-off following the pre-brewing, with a continuously operating pump 15 and pulsed control of valve or of valve 50A with pulses of period t1 and time interval t2 between two consecutive pulses.

Pump 15 operates during the coffee draw-off at maximum output and is typically designed to generate a pressure of typically 15 bar.

When fourth fluid line 40 is connected to hot water supply device 22, the pressure of the brewing water in the brewing chamber of brewing unit 31 drops. The size of the pressure drop during one pulse of time period t1 depends on the size of t1, thus the time frame, during which fourth fluid line is respectively connected to the hot water supply device. If t1 is large (e.g., greater than 1 second), then the pressure of the brewing water in the brewing chamber may drop to approximately 0 bar, when valve 50 or valve 50A releases fluid line 40.

1. A brewing device (1) for preparing a hot beverage, in particular an automated coffee machine, wherein the brewing device (1) has the following:
a hot water supply device (22) with an outlet (22A) for hot water;
a brewing unit (31) for carrying out a brewing process for preparing a brewed hot beverage, which has a fluid outlet line (36) and is configured for receiving hot water from the hot water supply device (22) during the brewing process and for dispensing the brewed hot beverage through a fluid outlet line (36) into a hot beverage outlet (65);
a hot water bypass line (40);
a controllable hot water switching device (50, 50A) which is configured for temporarily connecting the hot water bypass line (40) to the outlet (22A) of the hot water supply device (22) so that hot water is enabled to be supplied from the hot water supply device into the hot water bypass line (40), wherein the hot water bypass line (40) extends in such a way that hot water supplied in the hot water bypass line (40) is enabled to be dispensed into the hot beverage outlet (65);
a control unit (5) for controlling the hot water switching device (50, 50A),
wherein
the hot beverage outlet (65) comprises at least one hot beverage dispensing line (60), wherein the fluid outlet line (36) opens into the at least one hot beverage dispensing line (60) downstream of the brewing unit (31) such that the brewed hot beverage is enabled to be dispensed through the at least one hot beverage dispensing line (60) of the hot beverage outlet (65), and wherein the hot water bypass line (40) opens into the at least one hot beverage dispensing line (60) downstream of the hot water switching device (50, 50A), such that hot water is enabled to be dispensed through the at least one hot beverage dispensing line (60) of the hot beverage outlet (65).

2. The brewing device (1) according to claim 1, wherein the hot water supply device (22) is configured to supply hot water from a single hot water source.

3. The brewing device (1) according to claim 1, wherein the hot water switching device (50, 50A) is configured to be controlled by the control unit (5) in such a way that the hot water bypass line (40) is at least temporarily connected to the hot water supply device (22) during the brewing process.

4. The brewing device (1) according to claim 1,
wherein the hot water supply device (22) is designed to dispense a predefined amount of hot water during the brewing process via the outlet (22A) of the hot water supply device (22);
wherein the hot water switching device (50, 50A) is configured be controlled by the control unit (5) in such a way that the hot water bypass line (40) is temporarily connected to the hot water supply device (22) during the brewing process and a part of the predefined amount of hot water dispensed via the outlet (22A) of the hot water supply device (22) is dispensed through the at least one hot beverage dispensing line (60) of the hot beverage outlet (65), and
wherein the brewing unit (31) has an inlet (31A) for receiving hot water, said inlet (31A) being connected to the outlet (22A) of the hot water supply device (22) via a fluid line (30) such that the other part of the predefined amount of hot water dispensed via the outlet (22A) of the hot water supply device (22) is enabled be supplied to the inlet (31A) of the brewing unit (31) during the brewing process.

5. The brewing device (1) according to claim 1, wherein the hot water switching device (50) is a valve, in particular a 2/2-way solenoid valve with one inlet, one outlet, a throughput position, in which the input is connected to the outlet, and an interrupted position, in which the inlet is not connected to the outlet, wherein the inlet of the valve is connected to the outlet (22A) of the hot water supply device (22), wherein the outlet of the valve is connected to the hot water bypass line (40), and wherein a fluid line (25) upstream of the inlet of the valve establishes a connection between the outlet (22A) of the hot water supply device (22) and an inlet (31A) of the brewing unit (31).

6. The brewing device (1) according to claim 1, wherein the hot water switching device (50A) is a valve, in particular a 3/2-way solenoid valve, with one inlet, one first outlet, one second outlet, a first position, in which the inlet is connected to the first outlet, and a second position, in which the inlet is connected to the second outlet, wherein the inlet of the valve is connected to the outlet (22A) of the hot water supply device (22), wherein the first outlet of the valve is connected to the hot water bypass line (40), and wherein the second outlet of the valve is connected to an inlet (31A) of the brewing unit (31).

7. The brewing device (1) according to claim 1, wherein the control unit (5) is configured to control the hot water switching device (50, 50A) during the brewing process in at least one time interval or in a plurality of time intervals in such way that each time interval comprises a first time period (t1), in which the hot water bypass line (40) is connected to the hot water supply device (22), and a second time period (t2), in which the hot water bypass line (40) is not connected to the hot water supply device (22).

8. The brewing device (1) according to claim 7, wherein the ratio of the first time period (t1) to the second time period (t2) is defined or is enabled to be defined depending on a type of hot beverage to be prepared.

9. The brewing device (1) according to claim 7, wherein the first time period (t1) of at least one of the intervals is shorter than the associated second time period (t2) of the respective interval.

10. The brewing device (1) according to claim 1, which has a volume measuring device (12) which is configured to measure a volume (V) of the fluid discharged into the hot beverage outlet (65) over time and to output the associated measured values to the control unit (5), wherein the control unit (5) is further configured to control the hot water switching device (50, 50A) depending on the measured values from the volume measuring device (12).

11. The brewing device (1) according to claim 10, wherein the hot water switching device (50, 50A) is configured to be controlled during the brewing process by the control unit (5) in such a way that the hot water switching device (50, 50A) alternatingly switches between a first position, in which the hot water bypass line (40) is not connected to the hot water supply device (22), and a second position, in which the hot water bypass line (40) is connected to the hot water supply device (22), if a measured value for the volume (V) of the fluid dispensed into the hot beverage outlet (65), determined by the volume measuring device (12), is greater than or equal to a first predefined volume (v1).

12. The brewing device (1) according to claim 11, wherein the control unit (5) is configured to end the control of the hot water switching device (50, 50A) if a measured value for the volume (V) of the fluid dispensed in the hot beverage outlet (65), determined by the volume measuring device (12), is greater than or equal to a second predefined volume (v2), wherein the second predefined volume (v2) is greater than the first predefined volume (v1).

13. The brewing device (1) according to claim 1, wherein the brewing device (1) is further configured to supply steam, in particular in the form of a steam surge, to the hot water bypass line (40).

14. A method for preparing a hot beverage, in particular a coffee beverage, in the brewing device (1) according to claim 1, wherein the method comprises:
determining a type of hot beverage to be prepared;
specifying, on the basis of the type of hot beverage to be prepared, at least one parameter for the control of the hot water switching device (50, 50A); and
controlling, by means of the control unit (5), the hot water switching device (50, 50A) according to the at least one parameter during the preparation of the hot beverage.

15. The method according to claim 14, wherein the parameter comprises one or more of the following variables: volume (V) of the fluid dispenses into the hot beverage outlet (65); first time period (t1) of an interval, in which the hot water bypass line (40) is connected to the hot water supply device (22); second time period (t2) of an interval, in which the hot water bypass line (40) is not connected to the hot water supply device (22); ratio of the first time period (t1) to the second time period (t2); change of the ratio of the first time period (t1) to the second time period (t2) over time.

16. The method according to claim 14, wherein the method further comprises:
after completion of the preparation of the hot beverage: supplying steam, in particular a steam surge, into the hot water bypass line (40).
